(19) United States
(12) Patent Application Publication
(10) Pub. No.: US 2025/0190658 A1
(43) Pub. Date: Jun. 12, 2025

(54) INTELLIGENT SYSTEMS AND CONTROL LOGIC FOR MODEL UPDATING AND DATA GENERATION FOR VIRTUAL WIND TUNNELS

(71) Applicant: GM Global Technology Operations LLC, Detroit, MI (US)

(72) Inventors: Vishal Raul, Northville, MI (US); Chih-hung Yen, Bloomfield Hills, MI (US); Scott E. Parrish, Farmington Hills, MI (US)

(73) Assignee: GM GLOBAL TECHNOLOGY OPERATIONS LLC, Detroit, MI (US)

(21) Appl. No.: 18/531,820

(22) Filed: Dec. 7, 2023

(51) Int. Cl. G06F 30/28; G06F 30/15

(52) U.S. Cl. CPC G06F 30/28; G06F 30/15

(57) ABSTRACT

A method of operating a CFD system includes a system file interface receiving a data file defining a 3D model of a surface geometry, and a system controller extracting select surface information of the 3D model from the data file. The controller generates a DOE model set containing baseline and modified 3D models derived from the 3D model's extracted surface information, and determines for the baseline and modified 3D models if existing training geometry data is stored in a model training database. A CFD simulation module predicts new training model data, which contains a new training geometry data set for each baseline/modified 3D model that does not have existing training geometry data stored in the training database. An AI training module generates a trained model based on the new training model data; the model is integrated into the CFD simulation module for future simulations of aerodynamic characteristics of surface geometries.

### INTRODUCTION

The present disclosure relates generally to computational fluid dynamics (CFD) systems. More specifically, aspects of this disclosure relate to artificial intelligence (AI) powered virtual wind tunnels for modeling aerodynamic characteristics of vehicles.

Aerodynamically optimizing the exterior surface geometries of a vehicle is oftentimes a long and complex process that necessitates multiple iterations of surface design and analysis processes. A vehicle clay model process, for example, may begin with a designer hand crafting a desired vehicle body geometry out of a block of clay, and then utilizing a computer aided design (CAD) tool to map the clay model and generate a three-dimensional (3D) digital representation of its geometry. The clay model is then mounted inside a wind tunnel to measure fluid flow characteristics of the clay model's surface geometry, such as aerodynamic drag and lift. These fluid flow measurements are analyzed to determine what, if any, changes need to be made to the body geometry to improve the vehicle's aerodynamic performance. Aerodynamically optimizing a vehicle's body geometry using the clay model process may take multiple days per iteration and, thus, may require hundreds of hours of labor and resources. Moreover, the clay model process is limited in practical application since wind tunnel testing results are typically static and do not provide predictive information that a designer can use for future design cycles.

Rather than use a physical model to derive the fluid flow characteristics of a vehicle geometry, a computational fluid dynamics simulation process may be employed in which a CAD-generated data file defining a 3D model of a vehicle body shape is subjected to mathematical modeling and analysis. For the simulation process, a dense point cloud or wireframe mesh within the data file is evaluated using CFD data structure and numerical analysis to predict drag and lift estimates, boundary conditions, surface pressure, etc., for the subject geometry After reviewing the CFD-derived estimates, the designer may make alterations directly to the 3D model and repeat the CFD simulation and analysis process for the altered design. Unlike clay modelling and wind tunnel testing approaches, CFD analysis is less time consuming, less labor intensive, and can provide insights into flow structures and forces experienced by the vehicle during actual operation.

### SUMMARY

Presented below are CFD simulation systems with control logic that provision data generation and model updating for AI-powered virtual wind tunnels (AIVWT), methods for making and methods for using such systems, and non-transient, memory-stored instructions for operating such systems. By way of illustration, and not limitation, an intelligent, closed-loop CFD simulation system autonomously generates model training data and updates shape-centric, AI-based aerodynamics models to continually improve model capabilities and accuracy for AIVWTs. During regular usage of the AIVWT tool, for example, the CFD system systematically gathers new model data and related model aerodynamics data in order to update the system's AI-trained models. In many instances, a complete model update strategy is not possible or available, i.e., when finding gaps in an existing AI machine-learning (ML) model (legacy data) and variations in new surface data that is outside the existing model's scope, it is not always possible to find all of the uncertainty locations in a dense point cloud data file (e.g., 12M+ pixels/image and 500+ images/data set). In addition, computation resources may be limited, an indefinite number of designs may be possible, and future design directions may not be predictable. To address the foregoing issues, disclosed CFD simulation systems may add samples to a specific region of interest; as designs are added based on user inputs, the system tracks and aligns model data and training with future design objectives while adding samples to update the model training dataset. In so doing, the CFD system enables the user to derive aerodynamic characteristic estimates for a subject surface geometry using either HPC CFD simulation or existing AI-trained models, e.g., thus using less computational resources compared to deriving an entirely new DOE plan.

Aspects of this disclosure are directed to CFD simulation system control protocols, memory-stored instructions, and system control logic for provisioning automated data generation and model updating for AI-trained CFD models. In an example, a method is presented for operating a computational fluid dynamics system that predicts aerodynamic characteristics of surface geometries. This representative method includes, in any order and in any combination with any of the above and below disclosed options and features: receiving, e.g., via a CFD file interface of a CFD simulation system (e.g., meshing tool import/export interface), a data file that contains a 3D model of a subject surface geometry; extracting, e.g., via a CFD system microcontroller unit, control module, logic circuit, or network of control circuits/modules/devices (collectively “controller”) of the CFD system, select surface information of the 3D model from the data file; generating, e.g., via the system controller, a design of experiment (DOE) model set that contains at least one baseline 3D model and at least one modified 3D model, all of which are derived from the extracted surface information of the 3D model; determining, e.g., via the system controller for each baseline/modified 3D model, if an existing training geometry data set is already stored in a model training database of the CFD system; predicting, e.g., via a CFD simulation module of the CFD system, new training model data that contains a respective new training geometry data set for each baseline/modified 3D model that does not have existing training geometry data stored in the model training database; and generating, e.g., via an AI training module of the CFD system (e.g., a graph neural network (GNN), 3D convolution neural network (CNN), deep neural network (DNN), etc.) based on the new training model data, an AI-trained model that is integrated into the CFD system for future simulations of aerodynamic characteristics of surface geometries (e.g., the new AI-trained model can be retrieved to derive a subject surface's aerodynamic characteristics without having to run a full HPC CFD simulation).

Aspects of this disclosure are also directed to computer-readable media (CRM) for automating data generation and model updating for AI-based CFD simulation systems. In an example, a non-transitory CRM stores instructions that are executable by one or more processors of a CFD system controller to optimize simulation and prediction of aerodynamic characteristics of surface geometries. These instructions, when executed by the processor(s), cause the controller to perform operations, including: receiving, through a CFD file interface of a CFD system, a data file defining a 3D model of a surface geometry; extracting select surface information of the 3D model from the data file; generating a DOE model set containing a baseline 3D model and a modified 3D model both derived from the extracted surface information of the 3D model; determining, for each of the baseline 3D model and the modified 3D model, if an existing training geometry data set is stored in a model training database of the CFD system; predicting, using a CFD simulation module of the CFD system, new training model data containing a new training geometry data set for each of the baseline 3D model and the modified 3D model not having the existing training geometry data set stored in the model training database; and generating, using an AI training module of the CFD system based on the new training model data, an AI-trained model that is integrated into the CFD system for future simulations of aerodynamic characteristics of surface geometries.

Aspects of this disclosure are also directed to CFD simulation systems for predicting select aerodynamic characteristics of subject surface geometries, including for both automotive and non-automotive applications alike. In an example, a CFD system includes a single or multiple database storage devices, such as a model training database that stores model training data and a trained model database that stores AI-trained models. The CFD system also includes a CFD file interface that receives data files defining 3D models of subject surface geometries, and a CFD system controller that is operatively connected to the CFD file interface and the CFD system database(s). The CFD system controller is programmed to: extract select surface information of the 3D model from the data file; generate a DOE model set that contains one or more baseline 3D models and one or more modified 3D models, all of which are derived from the 3D model's extracted surface data; and determine, for each baseline/modified 3D model, if an existing training geometry data set is already stored in the model training database. The CFD system also includes a CFD simulation module that predicts a respective new training geometry data set for each baseline/modified 3D model that does not have an existing training geometry data set. An AI training module generates a new AI-trained model based on the new training model data; this new AI-trained model is then integrated into the CFD system for future simulations of aerodynamic characteristics of surface geometries.

For any of the disclosed systems, methods, and CRM, extracting select surface information of a 3D model from its data file may include exporting point cloud (PC) data and/or stereolithography (STL) data from a 3D surface mesh in the data file for one or more user-selected surfaces of the 3D model. Extracting select surface information may also include converting exported PC/STL data into a converted data model in a file format that is compatible with the DOE model. As another related option, each baseline 3D model is set as the converted data model whereas each modified 3D model is a respective alteration of the converted data model (e.g., change to surface angle, depth, height, etc.). For at least some applications, it may be desirable that there is a single baseline 3D model and multiple modified 3D models, each of which is a respective alteration of the baseline 3D model.

For any of the disclosed systems, methods, and CRM, an existing training geometry data set for a baseline/modified 3D model may include a respective CFD data set that is associated with a respective point cloud shape/STL file, both of which are stored in the model training database. As another option, the baseline/modified 3D models in the DOE model set may be preprocessed prior to predicting a new training model data. In this instance, preprocessing may include generating a respective closed volume geometry for each baseline/modified 3D model. As yet another option, CFD-generated new training model data may be postprocessed prior to generating a new AI-trained model. In this instance, postprocessing may include evaluating fluid velocity and surface flow data in the training model data and extracting therefrom drag coefficient, static pressure, flow shear stress, and/or other select aerodynamics data. Postprocessed new training model data may be stored in the CFD system's model training database prior to generating a new AI-trained model.

For any of the disclosed systems, methods, and CRM, each new AI-trained model may be stored in a trained model database, which may be the same database as or distinct database from the CFD system's model training database. It may be desirable that predicting new training model data is performed via the CFD simulation module on a high-performance computing (HPC) supercomputer or HPC computer cluster. As another option, the CFD file interface of the CFD system receives the data file defining the 3D model from a computer-aided design tool, e.g., using an interactive graphic-user-interface (GUI) based design tool. As another option, the system controller may predict a confidence level of a drag/lift estimate prior to extracting surface information. In this instance, extracting select surface information of a 3D model from a received data file may be responsive to a determination that the confidence level is below a predefined minimum confidence level. Predicting a confidence level may be performed using an anomaly detection method (e.g., isolation forest, local outlier factor, one-class support vector machine (SVM), etc.) or an uncertainty prediction method (e.g., dropout Bayesian approximation, deep ensemble approximation, etc.).

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a schematic diagram illustrating an example of a CFD simulation system for predicting aerodynamic characteristics of surface geometries in accord with aspects of the present disclosure.

FIG. 2 is a workflow diagram illustrating a representative system and method for automating data generation and model updating for AI-trained CFD models, which may correspond to memory-stored instructions that are executable by a resident or remote controller, control-logic circuit, programmable control unit, or other integrated circuit (IC) device or network of IC devices in accord with aspects of the disclosed concepts.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this Detailed Description, unless specifically disclaimed: the singular includes the plural and vice versa (e.g., indefinite articles “a” and “an” are to be construed as meaning “one or more” unless expressly disclaimed); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

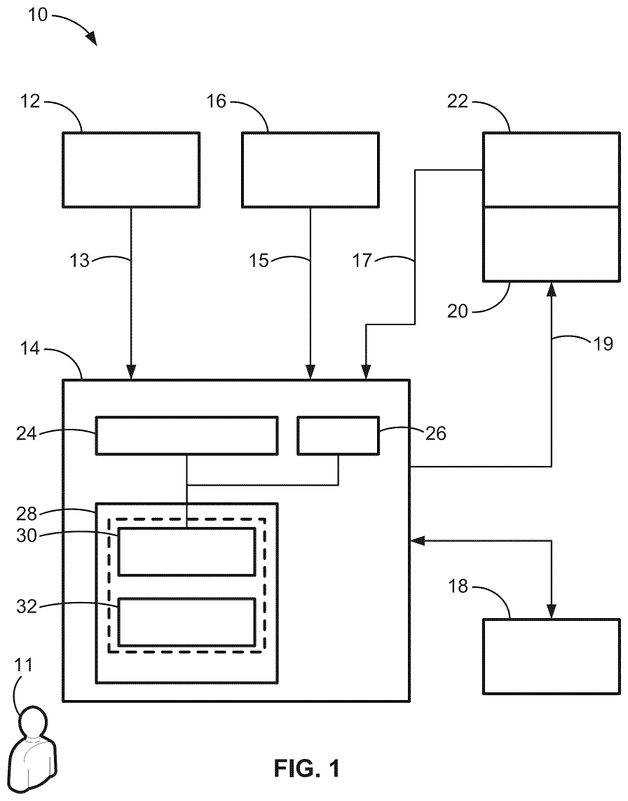

Referring now to the drawings, wherein like reference numbers refer to like features throughout the several views, there is shown in FIG. 1 a representative computational fluid dynamics (CFD) simulation system, which is designated generally at 10 and portrayed herein for purposes of discussion as an AI-powered virtual wind tunnel (AIVWT) for predicting aerodynamic characteristics of vehicle surface geometries. The illustrated CFD simulation system 10—also referred to herein as “CFD system”—is merely an exemplary architecture with which aspects of this disclosure may be practiced. In the same vein, utilization of the CFD system 10 to model and analyze the aerodynamic characteristics of the exterior surface geometry of an automobile body should be appreciated as a non-limiting application of disclosed features. As such, it will be understood that aspects and features of this disclosure may be incorporated into any logically relevant type of CFD system and may be utilized for both automotive and non-automotive applications alike. Moreover, only select components of the CFD simulation system 10 are shown and described in additional detail herein. Nevertheless, the CFD systems discussed below may include numerous additional and alternative features, and other available peripheral components, for carrying out the various methods and functions of this disclosure.

CFD simulation system 10 of FIG. 1 includes a file interface 12 by which a designer, engineer, technician, or other verified party (collectively “user”) 11 inputs a data file 13 that defines a 3D model of a subject surface geometry. The CFD file interface 12 may be an integrated software application accessed through a suitable user interface, such as a meshing tool import/export interface, or may be a suitable hardware device, such as a solid-state drive (SSD) hardware dock. To that end, the CFD system's file interface 12 may receive the data file defining the 3D model directly from a computer-aided design (CAD) tool, e.g., using an interactive graphic-user-interface (GUI) based design tool. The input data file 13 received by the file interface 12 may be representative of a design geometry of a multidimensional surface for which aerodynamic characteristics, such as drag, lift, moment, pressure, density, velocity, etc., are predicted by a fluid flow modeling (FFM) module 14.

With continuing reference to FIG. 1, the FFM module 14 is a mathematical modeling and analysis device that provides a mixture of services, both individually and through its communication with other networked devices. As non-limiting examples, the FFM module 14 communicates with the file interface 12, a boundary conditions database 16, a convolutional neural network (CNN) training module 18, an electronic video display device 20, and assorted user input controls 22 (e.g., keys, buttons, trackpads, touchscreens, mouse, etc.). This fluid flow modeling module 14 is generally composed of one or more processors 24, each of which may be embodied as a discrete microprocessor, an application specific integrated circuit (ASIC), or a dedicated control module. CFD simulation system 10 may offer centralized system control via a central processing unit (CPU) 26 that is operatively coupled to one or more electronic memory devices 28, each of which may take on the form of a CD-ROM, solid-state drive (SSD) memory, hard-disk drive (HDD) memory, semiconductor memory, flash memory, etc.

To facilitate fluid flow analysis for the select geometric surface, the FFM module 14 may optionally receive one or more inflow boundary conditions 15 from the boundary conditions database 16. Each inflow boundary condition 15 may be a default parameter, a user-input value, or an associated value retrieved from a look-up table. For instance, an inflow boundary condition may be an angle of attack with a default range of about −10 degrees to about 10 degrees. In a more specific example, the inflow boundary condition(s) 15 may contain a range of Reynolds numbers (Re) and a range of angles of attack (AoA). Once the data file 13, boundary conditions 15, and attendant user-input selections 17 are received, the FFM module 14 may initialize a CFD program 30 to simulate fluid flow around the 3D model of the surface geometry to thereby predict drag and lift estimates 19 for the subject surface geometry. Alternatively, the FFM module 14 may access a corresponding trained model from the CNN-trained model module 32 to derive drag and lift estimates 19 for the subject surface geometry. Drag and lift estimates 19 in the form of fluid flow output from FFM module 14 may include various aerodynamic “measurements” as the boundary conditions 15 are varied across respective ranges. In this example, the drag and lift outputs 19 may be tensors in the form of an X velocity (X-vel), a Y velocity (Y-vel), and a pressure field (Prsr). As shown, these output values may be displayed on the video display device 20 in the form of one or more intensity maps or “heat maps.” These estimates and maps may be stored in resident memory (CRM) 28 or at an off-board (e.g., cloud-based) database.

One or more interoperable programs, software applications, and resultant data/trained models, including the CFD program 30 and CNN-trained model module 32, may be stored in the resident memory 28 and may include an ordered listing of executable instructions and associated preprogrammed variables for implementing the logic functions, operations, and tasks of the disclosed CFD system 10 to generate drag and shape change feedback in the form of fluid flow outputs 19. The CFD program 30 and CNN-trained model module 32, when executed by the processor(s) 24, may cause the FFM module 14 to the perform logic, calculations, processes, and operations described herein for generating the drag and lift outputs. The CFD simulation system 10, once trained by the CNN training module 18, provides CFD simulation capabilities through the CFD program 30 and user-accessible trained models through the CNN-trained model module 32, e.g., to advantageously combine the benefits of CFD and wind-tunnel testing, by providing near real-time modeling and analysis related to changes in fluid flow around the exterior surface geometries of a vehicle body. While illustrated and described as a CNN-trained model, the CFD system 10 of FIG. 1 may utilize any of the other herein-described or later-developed AI-based neural network circuits suitable for CFD.

Discussed below are intelligent, closed-loop CFD simulation systems that autonomously gather design data, generate new model training data, and update shape-centric, AI-based aerodynamics models to continually improve model capabilities and accuracy for AIVWTs. This will allow the CFD system to persistently gather data and systematically update its CFD models with regular usage of the AI-powered virtual wind tunnel tool. Prediction confidence feedback is provided to identify geometric designs (e.g., missing vehicle shape files and attendant aerodynamics data) that need to be added to the model training dataset to optimize system precision and competences. When a need is identified, the CFD system automatically commences a “mini” DOE-type study based on the new design's geometry parameters or surfaces for CFD simulations.

Confidence prediction helps to identify where to add new samples to the model training dataset to help ensure an accurate and complete AI-trained model for future AIVWT usage. It is envisioned that a variety of different confidence prediction approaches may be utilized by the CFD simulation system, including assorted anomaly detection methods, such as one-class support vector machine (SVM) techniques, isolation forest techniques, local outlier factor techniques, etc. Other available confidence prediction approaches may include assorted uncertainty prediction methods, such as dropout Bayesian approximations, deep ensembles, etc. Samples are then added in each region of interest; the system automates surface extraction, CFD setup, HPC run, and adds new data into the dataset for each region. The model can then be updated at predetermined time durations. The new sample set may be associated with a user-defined set of interests such that the data is updated to align with design/studio direction as it grows. A limited number of samples may be added in regions of interest and, thus, does not necessitate a large DOE generation for each update with a resultant savings in computational resources.

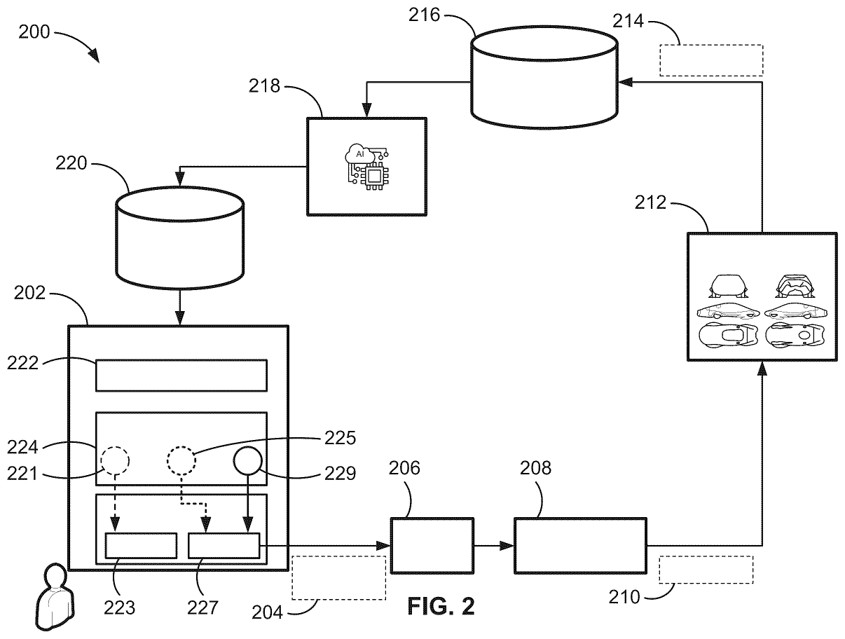

With reference next to the flow chart of FIG. 2, an improved system and method for automating new training model data generation and model updating for an AI-trained CFD system, such as CFD simulation system 10 of FIG. 1, is generally described at 200 in accordance with aspects of the present disclosure. Some or all of the operations illustrated in FIG. 2 and described in further detail below may be representative of an algorithm that corresponds to non-transitory, processor-executable instructions that are stored, for example, in main or auxiliary or remote memory (e.g., resident memory device(s) 28 of FIG. 1), and executed, for example, by an electronic controller, processing unit, dedicated control module, logic circuit, or other module or device or network of controllers/modules/devices (e.g., processor 24 and/or CPU 26 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 200 begins with a shape-centric AIVWT design tool 202 receiving a data file that contains a 3D model of a select surface geometry being analyzed to predict one or more aerodynamic characteristics of that surface geometry. As indicated above, a designer or engineer 11 may input a data file 13 containing a 3D model of a vehicle body exterior via a CFD file interface 12 of the CFD simulation system 10. In addition to the 3D model of the surface geometry, the user 11 may input additional simulation parameters for performing a simulation on the AIVWT design tool 202 (e.g., fluid flow speeds, angles of attack, inflow boundary conditions, etc.). The AIVWT design tool 202 may isolate select surface information (e.g., embedded within an .obj file, .nas file, or other CAD file that represents surface features), process user-input data and available numerical inputs (e.g., wheelbase, ride height, tire track, etc.), and uses available AI-trained models stored in database 220 to predict aerodynamic characteristics for the select surface geometry (e.g., lift, drag, surface sensitivity, surface pressure, wall shear stress, velocity field, volumetric pressure, other volumetric properties, etc.). From this information, a draft/lift (D/L) prediction module 222 of the AIVWT design tool 202 may output to the user 11 an initial set containing one or more or all of the aerodynamic characteristics for the select surface geometry. For at least some shape-centric AIVWT applications, the only input received by the user 11 is the 3D model data file.

A confidence prediction module 224 of FIG. 2 predicts a confidence level for the accuracy of the initial set of aerodynamic characteristics of the surface geometry. As noted above, confidence level prediction may be performed using a myriad of available techniques, including an anomaly detection method and/or an uncertainty prediction method. The confidence prediction module 224 then determines whether or not the predicted confidence level is at or above a predefined high (first) confidence level (e.g., ≥95% confidence). If the confidence level meets or exceeds the high confidence level, the confidence prediction module 224 may responsively output a green-colored HIGH CONFIDENCE alert 221 or similarly suitable notification to inform the user 11 that the predicted aerodynamic characteristics are likely accurate. As a further option, confidence prediction module 224 may also output a TRUST PREDICTION alert 223 indicating that the existing AI-trained CFD model is substantially accurate and, as such, supplemental training model data is not needed at that time.

Upon determining that the confidence level is less than the high confidence level, confidence prediction module 224 of FIG. 2 may responsively determine whether or not the predicted confidence level is at or above a predefined baseline (second) confidence level (e.g., ≥85% confidence). If the confidence level meets or exceeds the baseline confidence level, but is below the high confidence level, the confidence prediction module 224 may output an orange-colored MEDIUM CONFIDENCE alert 225 or similarly suitable notification to inform the user 11 that the initial set of aerodynamic characteristics may not be completely accurate. At the same time, confidence prediction module 224 may output a SIMULATE alert 227 indicating that the existing AI-trained CFD model may not be accurate and, as such, supplemental training model data may be needed at that time. Upon determining that the confidence level is less than the baseline confidence level, the confidence prediction module 224 may responsively output a red-colored LOW CONFIDENCE alert 229 to notify the user 11 that the initial set of aerodynamic characteristics may be invalid and, optionally, output the SIMULATE alert 227 indicating that supplemental training model data is needed at that time. The SIMULATE alert 227 may optionally include a user-selectable button by which the user 11 initiates the protocol for creating a new AI-trained model.

Responsive to a determination that the confidence level for the accuracy of the initial set of aerodynamic characteristics is below one or both of the above-mentioned predefined minimum confidence levels, the method 200 may advance to surface extraction node 204 and automatically commence a DOE-type study of the subject surface by first extracting select surface information of its 3D model from the data file. At this juncture, the AIVWT design tool 202 may identify select surface details from the designer-input 3D model, convert the extracted data to a DOE-compatible version, and analyze the data to identify what regions, if any, need an update (e.g., insufficient geometry data in database for AI-trained model). By way of non-limiting example, the AIVWT design tool 202 may export point cloud (PC) data, parasolid model/modeller transmit file (XT) data, and/or stereolithography (STL) data from a 3D surface mesh in the data file for a user-selected surface of the 3D model. Once exported, the AIVWT design tool 202 may convert the PC/XT/STL data to a data model in a file format that is compatible with a DOE model generated by a design of experiment module 206.

After extracting the select surface information from the model data file, DOE generation module 206 generates a design of experiment model and model set that contains at least one baseline 3D model and at least one modified 3D model, in which each baseline/modified 3D model is derived from the extracted surface information of the 3D model. A “design of experiment” in applied statistics, also referred to as “experimental design,” is the structured devising of a series of tasks for an experiment to plan, conduct, analyze, and interpret controlled tests in order to evaluate a set of input variables (factors) that control the value or output variables (responses) of a parameter or a group of parameters. In accord with the illustrated example, the DOE generation module 206 sets the extracted and converted surface(s) output from the surface extraction node 204 as the baseline 3D model. At the same time, the DOE generation module 206 creates multiple variations of the extracted surface, for example, creating 10 or more modified 3D models by making a slight variation to each of multiple surface segments (change angle, depth, height, etc.) of the baseline 3D model.

With continuing reference to FIG. 2, a database check module 208 evaluates each baseline 3D model and each modified 3D model to determine whether or not that model has a respective training geometry data set that already exists and is stored in a model training database 216 of the CFD simulation system 200. A training geometry data set may include an assortment of information, such as a respective point cloud (PC) and/or stereolithography (STL) shape file for that baseline/modified 3D model and a respective CFD data set associated with the respective PC/STL shape file. If a training geometry data set already exists for a given baseline/modified 3D model, the system/method 200 need not generate new training model data for that particular surface. For instance, if the database check module 208 determines that all baseline/modified 3D models in a DOE model set have existing training geometry data sets stored in the model training database 216, method 200 may temporarily terminate or may return to the AIVWT design tool 202.

Upon determining that one or more of the baseline/modified 3D models in a DOE model set do not have existing training geometry data sets, method 200 responsively advances to 3D model preprocessing node 210 and preprocesses each baseline/modified 3D model sans training geometry data. For instance, a baseline/modified 3D model may be preprocessed by generating a respective closed volume geometry—also referred to as a “watertight geometry”—for that 3D model, i.e., by closing any openings in the surface(s) of the 3D model. Each preprocessed 3D model is then passed from the preprocessing node 210 to an HPC CFD simulation module 212 to run a CFD simulation for that model.

HPC CFD simulation module 212 of FIG. 2 predicts new training model data for the DOE model set that was output by the DOE generation module 206 and processed through the preprocessing node 210. The new training model data generated by the HPC CFD simulation module 212 may contain a new set of training geometry data for each baseline/modified 3D model that was identified as not having existing training geometry data. It may be desirable that predicting new training model data be performed via the CFD simulation module 212 on a high-performance computing (HPC) supercomputer or HPC computer cluster. The HPC CFD simulation module 212 may employ any suitable CFD solver of choice for performing the CFD modeling and analysis, such as FLUENT®, ANSYS® Meshing, CFX®, STAR-CCM, POWERFLOW®, etc.

Method 200 advances from HPC CFD simulation module 212 to new model data post-processing node 214 and processes the new training model data prior to generating a new AI-trained model. In this instance, postprocessing the new training model data may include evaluating fluid velocity and surface flow data in the new training model data and extracting therefrom drag coefficient, lift coefficient, static pressure, volumetric flow properties, and flow shear stress data. In other words, post-processing node 214 evaluates all of the surface flow property information, velocity data, etc., that is output by the HPC CFD simulation module 212, and extracts only selected information that will be useful for training a new AI-trained model or updating an existing AI-trained model. These extracted segments of the training model data may be output by the post-processing node 214 and stored in the CFD system's model training database 216.

Using the new training model data output by the HPC CFD simulation module 212 and processed through the post-processing node 214, an AI model training module 218 generates a new AI-trained model that will be available to a user 11 of the AI-VWT 202 for future predictions of aerodynamic characteristics of input surface geometries. Typically, performed during the initial training process of a foundation model, the AI model training module 218 first devices a model architecture and set or related parameters (e.g., loss function, input format, hyperparameter initialization, etc.). AI model training module 218 of FIG. 2 then splits available data into a train data set and a test data set (80:20). If a larger volume of data is available, the training module 218 may split the available data into three distinct data sets:train and test and validation (60:20:20). The training module 218 uses the training data to train a model where loss function is reduced and model hyperparameters are tuned. At this juncture, train and test loss may be tracked, and model training may be stopped after a predefined number of iterations or achieving a predefined condition or set of conditions. The training module 218 may validate the newly trained model on a validation dataset. For a model update, new data may be split into train, test, and model data sets; training may start with hyperparameters from the foundational model. While numerous types of AI architectures may be employed for training a new model through CFD simulation, it may be desirable to employ a Convolution Neural Network (CNN) or a Graph Neural Network (GNN), the latter of which may be favored to provide lift/drag coefficients, surface field information, and volumetric field information. The new AI-trained model may be stored in a trained model database 220; models may be stored with certain nomenclature to indicate a revision number, date/time of update, etc.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating a computational fluid dynamics (CFD) system for predicting an aerodynamic characteristic of a surface geometry, the method comprising:
receiving, via a CFD file interface of the CFD system, a data file defining a three-dimensional (3D) model of the surface geometry;
extracting, via a CFD system controller of the CFD system, select surface information of the 3D model from the data file;
generating a design of experiment (DOE) model set containing a baseline 3D model and a modified 3D model both derived from the select surface information of the 3D model;
determining, for each of the baseline 3D model and the modified 3D model, if an existing training geometry data set is stored in a model training database of the CFD system;
predicting, via a CFD simulation module, new training model data containing a new training geometry data set for each of the baseline 3D model and the modified 3D model not having the existing training geometry data set stored in the model training database; and
generating, via an artificial-intelligence (AI) training module of the CFD system based on the new training model data, an AI-trained model integrated into the CFD system for future simulations of aerodynamic characteristics of surface geometries.

2. The method of claim 1, wherein extracting the select surface information of the 3D model from the data file includes exporting point cloud (PC) data and/or stereolithography (STL) data from a 3D surface mesh in the data file for a user-selected surface of the 3D model.

3. The method of claim 2, wherein extracting the select surface information further includes converting the exported PC data and/or STL data to a converted data model in a predefined file format compatible with the DOE model set.

4. The method of claim 3, wherein the baseline 3D model is set as the converted data model, and the modified 3D model is an alteration of the converted data model.

5. The method of claim 4, wherein the modified 3D model includes a plurality of modified 3D models each being a respective alteration of the converted data model.

6. The method of claim 1, wherein the existing training geometry data set includes a respective point cloud (PC) and/or stereolithography (STL) shape file and a respective CFD data set associated with the respective PC and/or STL shape file stored in the model training database.

7. The method of claim 1, further comprising preprocessing the DOE model set prior to predicting the new training model data, the preprocessing including generating a respective closed volume geometry for each of the baseline 3D model and the modified 3D model.

8. The method of claim 1, further comprising:
predicting, prior to extracting the select surface information of the 3D model, an estimated aerodynamic characteristic of the surface geometry;
determining a confidence level of the estimated aerodynamic characteristic of the surface geometry; and
determining if the confidence level is below a predefined minimum confidence level,
wherein extracting the select surface information of the 3D model is responsive to determining the confidence level is below predefined minimum confidence level.

9. The method of claim 8, wherein determining the confidence level is performed using an anomaly detection method and/or an uncertainty prediction method.

10. The method of claim 1, further comprising postprocessing the new training model data prior to generating the AI-trained model, the postprocessing including evaluating fluid velocity and surface flow data in the new training model data and extracting therefrom drag coefficient, static pressure, and flow shear stress data.

11. The method of claim 10, further comprising storing the postprocessed new training model data in the model training database of the CFD system prior to generating the AI-trained model.

12. The method of claim 11, further comprising storing the AI-trained model in a trained model database.

13. A non-transient, computer-readable medium storing instructions executable by one or more processors of a system controller of a computational fluid dynamics (CFD) system for predicting aerodynamic characteristics of surface geometries, the instructions, when executed by the one or more processors, causing the CFD system controller to perform operations comprising:
receiving, through a CFD file interface of the CFD system, a data file defining a 3D model of the surface geometry;
extracting select surface information of the 3D model from the data file;
generating a design of experiment (DOE) model set containing a baseline 3D model and a modified 3D model both derived from the select surface information of the 3D model;
determining, for each of the baseline 3D model and the modified 3D model, if an existing training geometry data set is stored in a model training database of the CFD system;
predicting, using a CFD simulation module of the CFD system, new training model data containing a new training geometry data set for each of the baseline 3D model and the modified 3D model not having the existing training geometry data set stored in the model training database; and
generating, using an artificial-intelligence (AI) training module of the CFD system based on the new training model data, an AI-trained model integrated into the CFD system for future simulations of aerodynamic characteristics of surface geometries.

14. A computational fluid dynamics (CFD) system for predicting an aerodynamic characteristic of a surface geometry of a vehicle, the CFD system comprising:
a model training database storing model training data;
a CFD file interface configured to receive a data file defining a 3D model of the surface geometry;
a CFD system controller operatively connected to the CFD file interface and the model training database, the CFD system controller being programmed to:
extract select surface information of the 3D model from the data file;
generate a design of experiment (DOE) model set containing a baseline 3D model and a modified 3D model both derived from the select surface information of the 3D model; and
determine, for each of the baseline 3D model and the modified 3D model, if an existing training geometry data set is stored in the model training database;
a CFD simulation module configured to predict new training model data containing a new training geometry data set for each of the baseline 3D model and the modified 3D model not having the existing training geometry data set stored in the model training database; and
an artificial-intelligence (AI) training module configured to generate an AI-trained model based on the new training model data, the AI-trained model being integrated into the CFD system for future simulations of aerodynamic characteristics of surface geometries.

15. The CFD system of claim 14, wherein extracting the select surface information of the 3D model from the data file includes exporting point cloud (PC) data and/or stereolithography (STL) from a 3D surface mesh in the data file for a user-selected surface of the 3D model.

16. The CFD system of claim 15, wherein extracting the select surface information further includes converting the exported PC data and/or STL data to a converted data model in a predefined file format compatible with the DOE model set.

17. The CFD system of claim 16, wherein the baseline 3D model is set as the converted data model, and the modified 3D model is an alteration of the converted data model.

18. The CFD system of claim 14, wherein the existing training geometry data set includes a respective point cloud (PC) and/or stereolithography (STL) shape file and a respective CFD data set associated with the respective PC and/or STL shape file stored in the model training database.

19. The CFD system of claim 14, wherein the CFD system controller is further programmed to preprocess the DOE model set prior to predicting the new training model data, the preprocessing including generating a respective closed volume geometry for each of the baseline 3D model and the modified 3D model.

20. The CFD system of claim 14, wherein the CFD system controller is further programmed to postprocessing the new training model data prior to generating the AI-trained model, the postprocessing including evaluating fluid velocity and surface flow data in the new training model data and extracting therefrom drag coefficient, static pressure, and flow shear stress data.
